(19) United States
(12) Patent Application Publication
(10) Pub. No.: US 2013/0093551 A1
(43) Pub. Date: Apr. 18, 2013

(54) R-Fe-B based magnet having gradient electric resistance and method for producing the same

(71) Applicants: Buzhuang Peng, Yantai (CN); Juntao Zhao, Yantai (CN); Guangjun Li, Yantai (CN)

(72) Inventors: Buzhuang Peng, Yantai (CN); Juntao Zhao, Yantai (CN); Guangjun Li, Yantai (CN)

(21) Appl. No.: 13/805,877

(22) PCT Filed: Dec. 24, 2010
(86) PCT No.: PCT/CN2010/080239

§ 371 Date: Dec. 20, 2012

(30) Foreign Application Priority Data
Jul. 6, 2010 (CN) 201010217943.1

(51) Int. Cl. H01F 7/02; H01F 41/02

(52) U.S. Cl. CPC H01F 7/02; H01F 41/0266
USPC 335/302; 419/6

(57) ABSTRACT

An R—Fe—B based magnet having gradient electric resistance and a method for producing the same are provided. The magnet includes an exterior layer (G) and a main body layer (H). The exterior layer (G) is connected with the main body layer (H) via a sintered layer (I). The oxygen content in the exterior layer (G) is higher than the oxygen content in the main body layer (H), so the electrical resistivity of the exterior layer (G) is not lower than the electrical resistivity of the main body layer (H). The R—Fe—B based magnet having gradient electric resistance is capable of maintaining high resistance and excellent magnetic performance simultaneously.

### CROSS REFERENCE OF RELATED APPLICATION

This is a U.S. National Stage under 35 USC 371 of the International Application PCT/CN2010/080239, filed on Dec. 24, 2010.

### BACKGROUND OF THE PRESENT INVENTION

1. Field of Invention

The present invention relates to a rare-earth permanent magnetic material, and more particularly to an R—Fe—B based magnet having gradient electric resistance and method for producing the same.

2. Description of Related Arts

In the conventional technologies, a permanent-magnet rotating motor mainly utilizes a ferrite magnet of low price. In recent years, with the miniaturization and high performance of various motors, application amount of R—Fe—B based sintered magnets with higher performance is increasing year by year. In particular, as countries around the world concern about issues of energy conservation and environmental protection recently, application range of the R—Fe—B based sintered magnet has expanded to areas such as home appliances, industrial equipments, electric vehicles and wind turbines. However, the R—Fe—B based sintered magnet is a metallic magnet with low resistance value. Thus, when the R—Fe—B based sintered magnet is applied to a rotating motor, problems of great eddy current loss, and drop of motor efficiency caused by the great eddy current loss appear.

In order to increase the electric resistance of the R—Fe—B based sintered magnet,

a Japanese patent of publication number JP9232122 discloses a high electric resistive magnet produced by adding Ge (Germanium) powder to R—Fe—B based magnetic powder, and by a process of plasma activated sintering;

a Japanese patent of publication number JP9186010 discloses a high electric resistive magnet produced by adding powder of fluoride or oxide of at least one element selected from the group consisting of Li, Na, Mg, Ca, Ba and Sr to R—Fe—B based magnetic powder;

a Japanese patent of publication number JP2006310659 discloses a high electric resistive magnet produced by adding DyF₃ and/or TbF₃ to R—Fe—B based magnetic powder;

a Japanese patent of publication number JP2006310660 discloses a high electric resistive magnet produced by adding DyF₃ and/or TbF₃, and Al₂O₃ to R—Fe—B based magnetic powder; and

a Japanese patent of publication number JP2008060241 discloses a high electric resistive magnet produced by forming a rare-earth fluoride insulating layer on surfaces of R—Fe—B based magnetic particles which are obtained by HDDR processing.

However, all kinds of magnets mentioned above increase the electric resistance of the magnets at the expense of a sharp decline of magnetic property of the magnets simultaneously, which makes it difficult to apply the magnets to a high-power rotating motor.

### SUMMARY OF THE PRESENT INVENTION

In order to solve technical problems mentioned above, an R—Fe—B based magnet having gradient electric resistance which is capable of maintaining high electric resistance and excellent magnetic performance simultaneously, and method for producing the same are provided.

A method of producing an R—Fe—B based magnet having gradient electric resistance of the present invention, comprises steps of:
(1) preparing powder A and powder B, wherein

composition of the powder A is Rₐ-T_{b}-B_{c}-M_{d}-Nₑ, wherein R is at least one rare-earth element selected from the group consisting of Nd, Pr, Dy and Tb; T is at least one element selected from the group consisting of Fe and Co; B is Boron; M is at least one element selected from the group consisting of Cu, Ga and Al; N is at least one element selected from the group consisting of Zr, Ti, Nb and Hf; values of a, b, c, d and e which present weight percent of corresponding elements of the magnet are within scopes as following: 26≦a≦33, 0.9≦c≦1.1, 0.01≦d≦1.5, 0.01≦e≦1.5, and b is a balance,

composition of the powder B is Rₘ-Tₙ-BₓM_{y}-O_{z}, wherein:

R is at least one element selected from the group consisting of Nd, Pr, Dy, Tb Ce and Y;

T is at least one element selected from the group consisting of Fe and Co;

B is Boron;

M is at least one element selected from the group consisting of Mn, In, Ge, Ti, V, Cr, Ni, Ga, Ca, Cu, Zn, Si, P, S, C, Al, Mg, Zr, Nb, Ta, W, Mo, Pd, Ag, Cd, Sn and Sb;

O is oxygen;

values of m, n, x, y and z which present weight percent of corresponding elements of layers of the magnet are within scopes as following: 29≦m≦36, 0.9≦x≦1.1, 0.01≦y≦3, 0.02≦z≦1, n is a balance;
(2) filling the powder A and the powder B layer by layer in a mould along a direction of magnetic field orientation in an environment having oxygen content of less than 1%, wherein at least two layers are filled, and compacting in the magnetic field for alignment;
(3) sending the compact into a sintering furnace in an environment having oxygen content of less than 1%, sintering under 800˜1080° C. for 1˜4 hr followed by fast cooling, and performing aging under 900° C. for 1 hr, and 450˜600° C. for 1˜6 hr to obtain a high-quality permanent magnet material.

In the method of producing the R—Fe—B based magnet having gradient electric resistance of the present invention, raw materials for preparation of the powder A and the powder B in the step (1) comprise alloy α, alloy β and metal oxide,

wherein composition of the alloy α is Rₐ-T_{b}-B_{c}-M_{d}-Nₑ,

wherein R is at least one rare-earth element selected from the group consisting of Nd, Pr, Dy and Tb,

T is at least one element selected from the group consisting of Fe and Co; B is Boron,

M is at least one element selected from the group consisting of Cu, Ga and Al,

N is at least one element selected from the group consisting of Zr, Ti, Nb and Hf, and

values of a, b, c, d and e which present weight percent of corresponding elements of the magnet are within scopes as following: 26≦a≦33, 0.9≦c≦1.1, 0.01≦d≦1.5, 0.01≦e≦1.5, b is a balance,

composition of the alloy β is Rₘ-Tₙ-Bₓ-M_{y}-O_{z}, wherein

R is at least one element selected from the group consisting of Nd, Pr, Dy, Tb Ce and Y,

T is at least one element selected from the group consisting of Fe and Co,

B is Boron,

M is at least one element selected from the group consisting of Mn, In, Ge, Ti, V, Cr, Ni, Ga, Ca, Cu, Zn, Si, P, S, C, Al, Mg, Zr, Nb, Ta, W, Mo, Pd, Ag, Cd, Sn and Sb,

O is oxygen, and

values of m, n, x, y and z which present weight percent of corresponding elements of layers of the magnet are within scopes as following: 29≦m≦36, 0.9≦x≦1.1, 0.01≦y≦3, 0.02≦z≦1, n is a balance,

wherein preparation methods of the powder A and the powder B are selected from one or combination of the following methods:

(i) processing the alloy α and the alloy β respectively by hydrogen decrepitation with a hydrogen furnace, grinding flakes of the alloy α to form the powder A in an environment under protection of inert gas or nitrogen; grinding the alloy β with a jet mill to form fine powder B in an environment having oxygen content of at least 1%;

(ii) processing the alloy α by hydrogen decrepitation with a hydrogen furnace, processing fine-grinding with a jet mill to obtain the powder A in an environment under protection of inert gas or nitrogen, then mixing the powder A and metal oxide to obtain the powder B, wherein the weight of the metal oxide mixed is more than 1% of the total weight of the powder A and the metal oxide;

(iii) separating the grinded powder formed by processing the alloy α in a hydrogen furnace into two parts; fine-grinding one part of the powder with a jet mill to form powder A in an environment under protection of insert gas or nitrogen, fine-grinding the other part with a jet mill to form powder B in an environment having oxygen content of at least 1%;

(iv) grinding the alloy α and the alloy β respectively, grinding the alloy α to obtain the powder A in an environment under protection of inert gas or nitrogen, mixing the alloy α and the alloy β with a certain proportion, wherein a ratio of the alloy α to the alloy β is not less than 10:1, processing fine-grinding with a jet mill to obtain the powder B in an environment having oxygen content of at least 1%;

(V) grinding the alloy α, processing fine-grinding with a jet mill to obtain the powder A in an environment under protection of inert gas or nitrogen, then mixing part of the powder A and metal oxide to obtain the powder B, wherein the weight of the metal oxide mixed is not less than 1% of the total weight of the part of powder A mixed and the metal oxide; and

(vi) separating grinded powder formed by grinding the alloy α into two parts, fine-grinding one part of the powder with a jet mill to form the powder A in an environment under protection of inert gas or nitrogen, fine-grinding the other part of the powder with a jet mill to obtain the powder B in an environment having oxygen content of at least 1%.

In the method of producing the R—Fe—B based magnet having gradient electric resistance, thickness of the filled layer of the powder B in the step (2) accounts for less than 50% of total thickness.

The R—Fe—B based magnet having gradient electric resistance comprises an exterior layer G and a main body layer H, wherein the exterior layer G is connected with the main body layer H via a sintered layer I; oxygen content of the exterior layer G is more than that of the main body layer H, and electrical resistivity of the exterior layer G is not lower than that of the main body layer H.

In the R—Fe—B based magnet having gradient electric resistance, thickness of the exterior layer G accounts for less than 50% of total thickness of the R—Fe—B based magnet in a direction of magnetic field orientation.

In the R—Fe—B based magnet having gradient electric resistance, oxygen content of the exterior layer G is more than 0.2%.

In the R—Fe—B based magnet having gradient electric resistance, coercive force of the exterior layer G is larger than that of the main body layer H.

The manufacturing method of the R—Fe—B based magnet having gradient electric resistance provides an R—Fe—B based permanent magnet material having characteristics of high electric resistance, high coercive force and excellent magnetic performance Applying the R—Fe—B based permanent magnet in a rotor of a middle/high-power and high-speed rotating motor can reduce loss of the rotating motor, and improve efficiency thereof.

Combined with the accompanying drawings, the R—Fe—B based magnet having gradient electric resistance and method for producing the same, according to preferred embodiments of the present invention, are further illustrated as following

### BRIEF DESCRIPTION OF THE DRAWINGS

FIG. 1 is an SEM analysis image showing an exterior layer G according to embodiment 1 of the manufacturing method of an R—Fe—B based magnet having gradient electric resistance of the present invention.

FIG. 2 is an SEM analysis image of an exterior layer G according to embodiment 3 of the producing method of an R—Fe—B based magnet having gradient electric resistance of the present invention.

FIG. 3 is a structural schematic view of an R—Fe—B based magnet having gradient electric resistance of the present invention.

### DETAILED DESCRIPTION OF THE PREFERRED EMBODIMENT

### Embodiment 1

Prepare a raw material having a purity of over 99 wt % according to the following composition (weight percentage): (Nd₂₁Pr₅Dy_{4.5})Co₂Cu_{0.15}Al_{0.1}Nb_{0.2}B₁Fe_{balance}, melt in a vacuum strip continuous casting furnace, and send flakes into a hydrogen furnace to form hydrogen decrepitation particles;

in an oxygen-free environment with oxygen content close to 0%, send the particles after hydrogen decrepitation into a jet mill to process fine-grinding, so as to obtain a powder A with an average particle size of d=3.3 μm, add Dy₂O₃ powder with an average particle size of d=3.2 μm to a part of the powder A, wherein the weight of the Dy₂O₃ powder added is 3% of the total weight of the part of the powder A added and the Dy₂O₃ powder, and mix them uniformly to form powder B;

in an environment having oxygen content of less than 1% send the powder A and the powder B into a magnet oriented molding device, fill along a magnetizing direction layer by layer with spacing boards, wherein volume ratio of the powder A to the powder B is 3.6:1, and compact the filled powder in a magnetic field for alignment; in an environment having oxygen content of less than 1% sinter the compact under 1080° C. for 4 hrs followed by fast cooling, and perform aging under 900° C. for 3 hrs and under 520° C. for 4 hrs respectively to form a rectangular magnet A1 having a size of 51×51×22 mm, wherein thickness of an exterior layer G is 6 mm, and thickness of a main body layer H is 16 mm. Produce a D10×20 cylinder for measuring magnetic property thereof. Produce a tall and slender rod having a size of 1×1×5 mm along the magnetizing direction in the exterior layer G and the main body layer H for measuring resistivity thereof. Measuring results are shown in Table 1.

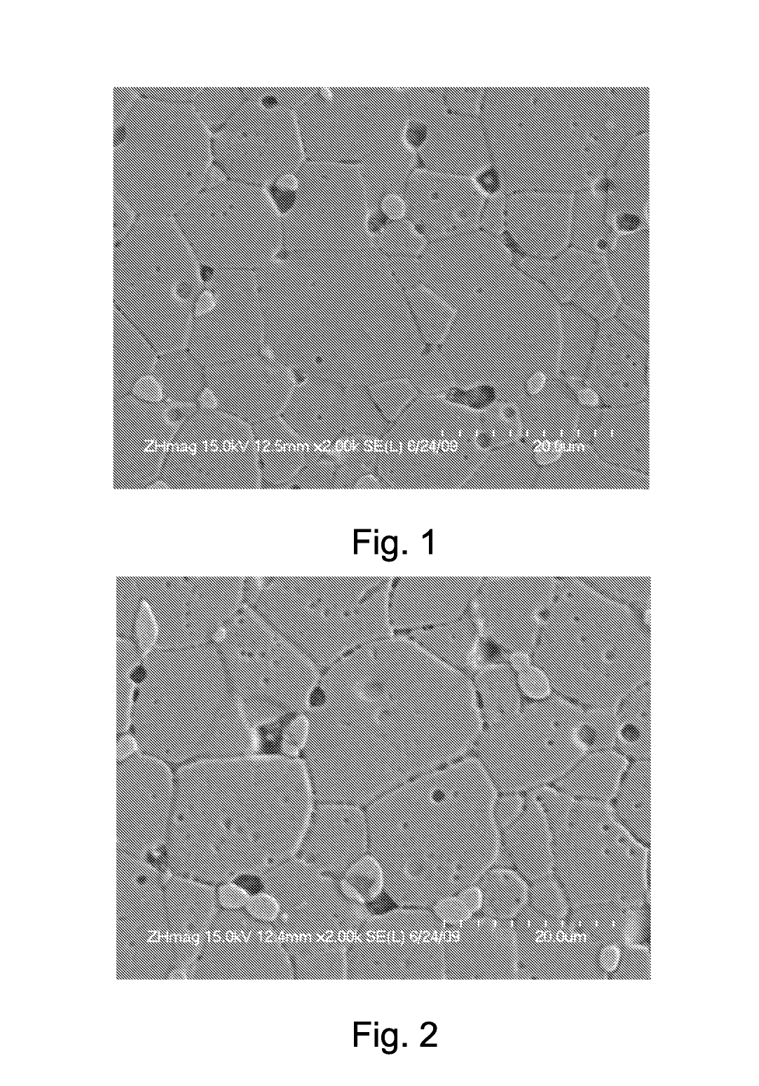

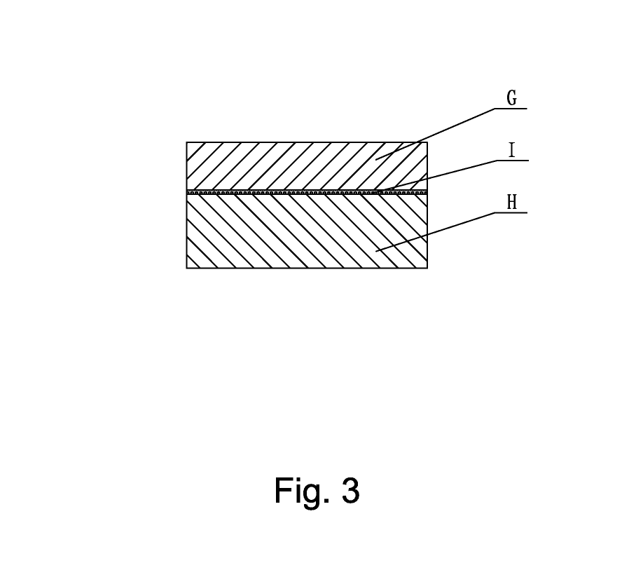

SEM (scanning electron microscope) analysis image is shown in FIG. 1. It can be seen from FIG. 1 that oxide particles having equivalent circle diameter of 1.2 μm are dispersed in the exterior layer G by an amount of 3600 particles per square millimeter. Area fraction that the oxide particles stated above occupy is at least 9.6%.

The magnet obtained in the embodiment 1 has characteristics of high electric resistance, high coercive force and excellent magnetic performance. When the magnet is applied to a rotor in a rotating motor having a high-speed and middle/high-power, eddy current loss of the rotating motor can be reduced and electrical efficiency of the rotating motor thus can be improved.

Comparison 1

Prepare a raw material having a purity of over 99 wt % according to the following composition (weight percentage): (Nd₂₁Pr₅Dy_{4.5})Co₂Cu_{0.15}Al_{0.1}Nb_{0.2}B₁Fe_{balance}, melt in a vacuum strip continuous casting furnace, and send flakes into a hydrogen furnace to form hydrogen decrepitation particles;

in an oxygen-free environment with oxygen content close to 0%, send the particles after hydrogen decrepitation into a jet mill to process fine-grinding, so as to obtain a powder with an average particle size of d=3.3 μm;

in an environment having oxygen content of less than 1%, send the powder into a magnet oriented molding device to compact; in an environment having oxygen content of less than 1% sinter the compact under 1080° C. for 4 hrs followed by fast cooling, and perform aging under 900° C. for 3 hrs and under 520° C. for 4 hrs respectively to form a rectangular magnet B1 having a size of 51×51×22 mm. Produce a tall and slender rod having a size of 1×1×5 mm for measuring resistivity thereof. Measure results are shown in Table 1.

It can be seen from Table 1 that the magnet A1 produced by the method of the embodiment 1 has only about half of the eddy current loss of the magnet B1 produced by conventional method.

### Embodiment 2

Prepare a raw material having a purity of over 99 wt % according to the following composition (weight percentage): (Nd₂₁Pr₅Dy_{4.5})Co₂Cu_{0.15}Al_{0.1}Nb_{0.2}B₁Fe_{balance}, melt in a vacuum strip continuous casting furnace, and send flakes into a hydrogen furnace to form hydrogen decrepitation particles;

in an oxygen-free environment with oxygen content close to 0%, send one part of particles after hydrogen decrepitation into a jet mill to process fine-grinding, so as to obtain a powder A with an average particle size of d=3.3 μm; send the other part of the particles after hydrogen decrepitation into a jet mill to process fine-grinding in an environment with oxygen content of 1.5%, so as to obtain a powder B with an average particle size of d=3.4 μm; send the powder A and the powder B into a magnet oriented molding device in an environment having oxygen content of less than 1%, fill along a magnetizing direction layer by layer with spacing boards, wherein volume ratio of the powder A to the powder B is 3.6:1, magnetize and mold after the powder is filled; send the compact into a sintering furnace in an environment having oxygen content of less than 1%, sinter the compact under 1075° C. for 4 hrs followed by fast cooling, and perform aging under 900° C. for 3 hrs and under 510° C. for 4 hrs respectively to form a rectangular magnet A2 having a size of 51×51×22 mm, wherein thickness of an exterior layer G is 6 mm, and thickness of a main body layer H is 16 mm. Produce a D10×20 cylinder for measuring magnetic property thereof. Produce a tall and slender rod having a size of 1×1×5 mm along a magnetizing direction in the exterior layer G and the main body layer H for measuring resistivity thereof. Measuring results are shown in Table 1.

### Embodiment 3

Prepare a raw material having a purity of over 99 wt % according to the following composition (weight percentage): (Nd₂₁Pr₅Dy_{4.5})Co₂Cu_{0.15}Al_{0.1}Nb_{0.2}B₁Fe_{balance}, melt in a vacuum strip continuous casting furnace, and send flakes into a hydrogen furnace to form hydrogen decrepitation particles;

in an oxygen-free environment with oxygen content close to 0%, send the particles after hydrogen decrepitation into a jet mill to process fine-grinding, so as to obtain a powder A with an average particle size of d=3.3 μm, add Al₂O₃ powder with an average particle size of d=1.5 μm to a part of the powder A, wherein the weight of the Al₂O₃ powder added is 1% of the total weight of the part of powder A added and the Al₂O₃ powder, and mix them uniformly to form a powder B;

in an environment having oxygen content of less than 1%, send the powder A and the powder B into a magnet oriented molding device, fill along a magnetizing direction layer by layer with spacing boards, wherein volume ratio of the powder A to the powder B is 3.6:1, and compact the filled powder in a magnetic field for alignment; in an environment having oxygen content of less than 1%, sinter the compact under 1090° C. for 4 hrs followed by fast cooling, and perform aging under 900° C. for 3 hrs and under 500° C. for 4 hrs respectively to form a rectangular magnet A3 having a size of 51×51×22 mm, wherein thickness of an exterior layer G is 6 mm, and thickness of a main body layer H is 16 mm. Produce a D10×20 cylinder for measuring magnetic property thereof. Produce a tall and slender rod having a size of 1×1×5 mm along a magnetizing direction in the exterior layer G and the main body layer H for measuring resistivity thereof. Measuring results are shown in Table 1.

SEM (scanning electron microscope) analysis results are shown in FIG. 2. It can be seen from FIG. 2 that oxide particles having equivalent particle size of 1.3 μm are dispersed in the exterior layer G by an amount of 4500 particles per square millimeter. Area fraction that the oxide particles stated above occupy is at least 12.6%.

### Embodiment 4

Prepare an alloy α with a raw material having a purity of over 99 wt % according to the following composition (weight percentage): Nd₂₄Pr₅Co₁Al_{0.1}Zr_{0.2}B₁Fe_{balance}, prepare an alloy β with a raw material having a purity of over 99 wt % according to the following composition (weight percentage): Nd₂₅Dy₄₅Co₂₀Cu₂Al₂B_{0.4}Fe_{balance},

melt the alloy α and the alloy β in a vacuum strip continuous casting furnace respectively, and send them into a hydrogen furnace to form hydrogen decrepitation particles α and β separately;

in an oxygen-free environment with oxygen content close to 0%, send one part of particles a after hydrogen decrepitation into a jet mill to process fine-grinding, so as to obtain a powder A with an average particle size of d=3.3 μm, and mix the other part of the particles α after hydrogen decrepitation and the particles β after hydrogen decrepitation according to weight percentage of 91:9,

after mixed uniformly, in an environment having oxygen content of 1.2%, fine-grind with a jet mill to form a powder B having an average particle diameter of 3.4 μm;

in an environment having oxygen content of less than 1%, send the powder A and the powder B into a magnet oriented molding device, fill along a magnetizing direction layer by layer with spacing boards, wherein volume ratio of the powder A to the powder B is 3.6:1, and compact the filled powder in a magnetic field for alignment in an environment having oxygen content of less than 1%, sinter the compact under 1085° C. for 5 hrs followed by fast cooling, and perform aging under 900° C. for 3 hrs and under 500° C. for 4 hrs respectively to form a magnet A4 having a size of 51×51×22 mm, wherein thickness of an exterior layer G is 6 mm, and thickness of a main body layer H is 16 mm. Produce a D10×20 cylinder for measuring magnetic property thereof. Produce a tall and slender rod having a size of 1×1×5 mm along a magnetizing direction in the exterior layer G and the main body layer H for measuring resistivity thereof. Measuring results are shown in Table 1.

Comparison 2

Prepare an alloy α with a raw material having a purity of over 99 wt % according to the following composition (weight percentage): Nd₂₄Pr₅Co₁Al_{0.1}Zr_{0.2}B₁Fe_{balance},

prepare an alloy β with a raw material having a purity of over 99 wt % according to the following composition (weight percentage): Nd₂₅Dy₄₅Co₂₀Cu₂Al₂B_{0.4}Fe_{balance},

melt the alloy α and the alloy β in a vacuum strip continuous casting furnace respectively, and send them into a hydrogen furnace to form hydrogen decrepitation particles α and β separately;

after hydrogen decrepitation mix the particles α and the particles β according to weight ratio of 91:9,

after mixed uniformly, in an environment having oxygen content of 1.2%, fine-grind with a jet mill to form a powder B having an average particle diameter of 3.4 μm;

in an environment having oxygen content of less than 1%, send the powder A and the powder B into a magnet oriented molding device, magnetize and mold after the powder is filled, and compact the filled powder in a magnetic field for alignment; in an environment having oxygen content of less than 1% sinter the compact under 1085° C. for 5 hrs followed by fast cooling, and perform aging under 900° C. for 3 hrs and under 500° C. for 4 hrs respectively to form a magnet B2 having a size of 51×51×22 mm. Produce a tall and slender rod having a size of 1×1×5 mm for measuring resistivity thereof. Measuring results are shown in Table 1.

### Embodiment 5

Prepare a raw material having a purity of over 99 wt % according to the following composition (weight percentage): (Nd₂₁Pr₅Dy_{4.5})Co₂Cu_{0.15}Al_{0.1}Nb_{0.2}B₁Fe_{balance},

melt in a vacuum strip continuous casting furnace, and send flakes into a hydrogen furnace to form hydrogen decrepitation particles;

in an oxygen-free environment with oxygen content close to 0%, send the particles after hydrogen decrepitation into a jet mill to process fine-grinding, so as to obtain a powder A with an average particle size of d=3.3 μm, add Ce₂O₃ powder with an average particle size of d=3.2 μm to the powder A, wherein the weight of the Ce₂O₃ powder added is 4% of the total weight of the powder A and the Ce₂O₃ powder, and uniformly mix them uniformly to form a powder B;

in an environment having oxygen content of less than 1% send the powder A and the powder B into a magnet oriented molding device, fill along a magnetizing direction layer by layer with spacing boards, wherein volume ratio of the powder A to the powder B is 3.6:1, and compact the filled powder in a magnetic field for alignment; in an environment having oxygen content of less than 1% sinter the compact under 1080° C. for 4 hrs followed by fast cooling, and perform aging under 900° C. for 3 hrs and under 530° C. for 4 hrs respectively to form a magnet A5 having a size of 51×51×22 mm, wherein thickness of an exterior layer G is 6 mm, and thickness of a main body layer H is 16 mm. Produce a D10×20 cylinder for measuring magnetic property thereof. Produce a tall and slender rod having a size of 1×1×5 mm along a magnetizing direction in the exterior layer G and the main body layer H for measuring resistivity thereof. Measuring results are shown in Table 1.

The magnets obtained according to the embodiment 4 and the embodiment 5 not only present excellent magnetic performance but also have characteristics of high electric resistance and low cost. The magnets manufactured by the embodiment 4 and the embodiment 5 have wide application prospects in embedded permanent magnetic motor.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

TABLE 1
Compositions and Magnetic Performances of the Magnets

| | | Oxygen | | | Electrical |
|---|---|---|---|---|---|
| | | content | Br | Hcj | resistivity |
| | Magnet type | (ppm) | (T) | (KA/m) | (μΩ·cm) |
| Embodiment 1 | Exterior layer | 4620 | 1.31 | 2155 | 860 |
| | G of A1 | | | | |
| | Main body | 718 | 1.36 | 1836 | 140 |
| | layer H of A1 | | | | |
| Embodiment 2 | Exterior layer | 3510 | 1.35 | 1751 | 650 |
| | G of A2 | | | | |
| | Main body | 720 | 1.35 | 1836 | 142 |
| | layer H of A2 | | | | |
| Embodiment 3 | Exterior layer | 5301 | 1.31 | 2032 | 1392 |
| | G of A3 | | | | |
| | Main body | 723 | 1.36 | 1836 | 145 |
| | layer H of A3 | | | | |
| Embodiment 4 | Exterior layer | 3511 | 1.37 | 1769 | 661 |
| | G of A4 | | | | |
| | Main body | 810 | 1.37 | 1826 | 150 |
| | layer H of A4 | | | | |
| Embodiment 5 | Exterior layer | 6630 | 1.21 | 1650 | 1016 |
| | G of A5 | | | | |
| | Main body | 690 | 1.26 | 1785 | 155 |
| | layer H of A5 | | | | |
| Comparison 1 | Magnet B1 | 720 | 1.36 | 1836 | 142 |
| Comparison 2 | Magnet B2 | 810 | 1.38 | 1826 | 150 |

### INDUSTRIAL APPLICABILITY

Raw materials adopted by the R—Fe—B based magnet having gradient electric resistance and method for producing the same are all currently existing raw materials for producing permanent magnets, and the production equipments adopted thereby are all currently existing conventional equipments. The R—Fe—B based magnets of the present invention are widely adopted in middle/high power and high speed rotating motors, and have positive effects, and thus have great market prospects and industrial applicability.

What is claimed is:

1. A method of producing an R—Fe—B based magnet having gradient electric resistance, comprising steps of:
(1) preparing powder A and powder B, wherein composition of the powder A is Rₐ-T_{b}-B_{c}-M_{d}-Nₑ, wherein R is at least one rare-earth element selected from the group consisting of Nd, Pr, Dy and Tb; T is at least one element selected from the group consisting of Fe and Co; B is Boron; M is at least one element selected from the group consisting of Cu, Ga and Al; N is at least one element selected from the group consisting of Zr, Ti, Nb and Hf; values of a, b, c, d and e which present weight percent of corresponding elements of the R—Fe—B based magnet are within scopes as following: 26≦a≦33, 0.9≦c≦1.1, 0.01≦d≦1.5, 0.01≦e≦1.5, and b is a balance,
composition of the powder B is Rₘ-Tₙ-Bₓ-M_{y}-O_{z}, wherein
R is at least one element selected from the group consisting of Nd, Pr, Dy, Tb Ce and Y;
T is at least one element selected from the group consisting of Fe and Co;
B is Boron;
M is at least one element selected from the group consisting of Mn, In, Ge, Ti, V, Cr, Ni, Ga, Ca, Cu, Zn, Si, P, S, C, Al, Mg, Zr, Nb, Ta, W, Mo, Pd, Ag, Cd, Sn and Sb;
O is oxygen, values of m, n, x, y and z which present weight percent of corresponding elements of layers of the magnet are within scopes as following: 29≦m≦36, 0.9≦x≦1.1, 0.01≦y≦3, 0.02≦z≦1, n is a balance;
(2) filling the powder A and the powder B layer by layer in a mould along a direction of magnetic field orientation in an environment having oxygen content of less than 1%, wherein at least two layers are filled, and compacting in the magnetic field for alignment;
(3) sending the compact into a sintering furnace in an environment having oxygen content of less than 1%, sintering under 800˜1080° C. for 1˜4 hr followed by fast cooling, and performing aging under 900° C. for 1 hr, and 450˜600° C. for 1˜6 hr to obtain a high-quality permanent magnet material.

2. The method of producing the R—Fe—B based magnet having gradient electric resistance, as claimed in claim 1, wherein raw materials for preparation of the powder A and the powder B comprise alloy α, alloy β and metal oxide,
wherein composition of the alloy α is Rₐ-T_{b}-B_{c}-M_{d}-Nₑ,
wherein R is at least one rare-earth element selected from the group consisting of Nd, Pr, Dy and Tb,
T is at least one element selected from the group consisting of Fe and Co; B is Boron,
M is at least one element selected from the group consisting of Cu, Ga and Al,
N is at least one element selected from the group consisting of Zr, Ti, Nb and Hf, and
values of a, b, c, d and e which present weight percent of corresponding elements of the magnet are within scopes as following: 26≦a≦33, 0.9≦c≦1.1, 0.01≦d≦1.5, 0.01≦e≦1.5, b is a balance,
composition of the alloy β is Rₘ-Tₙ-Bₓ-M_{y}-O_{z}, wherein
R is at least one element selected from the group consisting of Nd, Pr, Dy, Tb Ce and Y;
T is at least one element selected from the group consisting of Fe and Co;
B is Boron;
M is at least one element selected from the group consisting of Mn, In, Ge, Ti, V, Cr, Ni, Ga, Ca, Cu, Zn, Si, P, S, C, Al, Mg, Zr, Nb, Ta, W, Mo, Pd, Ag, Cd, Sn and Sb;
O is oxygen;
values of m, n, x, y and z which present weight percent of corresponding elements of layers of the R—Fe—B based magnet are within scopes as following: 29≦m≦36, 0.9≦x≦1.1, 0.01≦y≦3, 0.02≦z≦1, n is a balance,
wherein preparation methods of the powder A and the powder B are selected from one or combination of the following methods:
(i) processing the alloy α and the alloy β respectively in hydrogen furnace, grinding flakes of the alloy α to form the powder A in an environment under protection of inert gas or nitrogen; grinding the alloy β with a jet mill to form fine powder B in an environment having oxygen content of at least 1%;
(ii) processing the alloy α in hydrogen furnace, processing fine-grinding with a jet mill to form the powder A in an environment under protection of inert gas or nitrogen, then mixing the powder A and metal-oxide to obtain the powder B, wherein the weight of the metal oxide mixed is more than 1% of the total weight of the powder A and the Dy₂O₃ powder;
(iii) separating the grinded powder formed by processing the alloy α in a hydrogen furnace into two parts; fine-grinding one part of the powder with a jet mill to form powder A in an environment under protection of insert gas or nitrogen, fine-grinding the other part with a jet mill to form powder B in an environment having oxygen content of at least 1%;
(iv) grinding the alloy α and the alloy β respectively, grinding the alloy α to obtain the powder A in an environment under protection of inert gas or nitrogen, mixing the alloy α and the alloy β with a certain proportion wherein a ratio of the alloy α to the alloy β is not less than 10:1, processing fine-grinding with a jet mill to obtain the powder B in an environment having oxygen content of at least 1%;
(V) grinding the alloy α, processing fine-grinding with a jet mill to obtain the powder A in an environment under protection of inert gas or nitrogen, then mixing part of the powder A and metal oxide to obtain the powder B, wherein the weight of the metal oxide mixed is not less than 1% of the total weight of the part of powder A mixed and the metal oxide; and
(vi) separating grinded powder formed by grinding the alloy α into two parts, fine-grinding one part of the powder with a jet mill to form the powder A in an environment under protection of an inert gas or nitrogen, fine-grinding the other part of the powder with a jet mill to obtain the powder B in an environment having oxygen content of at least 1%.

3. The method of producing the R—Fe—B based magnet having gradient electric resistance, as claimed in claim 1, wherein thickness of a filled layer of the powder B in the step (2) accounts for less than 50% of total thickness.

4. An R—Fe—B based magnet having gradient electric resistance comprising an exterior layer G and a main body layer H, wherein said exterior layer G is connected with said main body layer H via a sintered layer I; oxygen content of said exterior layer G is more than that of said main body layer H, and electrical resistivity of said exterior layer G is not lower than that of said main body layer H.

5. The R—Fe—B based magnet having gradient electric resistance, as claimed in claim 4, wherein thickness of said exterior layer G accounts for less than 50% of total thickness of said R—Fe—B based magnet in the magnetic field orientation.

6. The R—Fe—B based magnet having gradient electric resistance, as claimed in claim 5, wherein oxygen content of said exterior layer G is more than 0.2%.

7. The R—Fe—B based magnet having gradient electric resistance, as claimed in claim 6, wherein coercive force of said exterior layer G is larger than that of said main body layer H.
